(19) United States
(12) Patent Application Publication
(10) Pub. No.: US 2016/0366317 A1
(43) Pub. Date: Dec. 15, 2016

(54) APPARATUSES AND METHODS FOR IMAGE BASED BIOMETRIC RECOGNITION

(71) Applicant: Delta ID Inc., Fremont, CA (US)

(72) Inventors: ALEXANDER IVANISOV, Newark, CA (US); SALIL PRABHAKAR, Fremont, CA (US)

(21) Appl. No.: 14/885,247

(22) Filed: Oct. 16, 2015

Related U.S. Application Data
(63) Continuation-in-part of application No. 14/738,505, filed on Jun. 12, 2015.

(51) Int. Cl. H04N 5/225; G06K 9/00

(52) U.S. Cl. CPC H04N 5/2256; G06K 9/00604; G06K 9/00617

(57) ABSTRACT

The invention relates to image based biometric recognition. In one aspect, the invention includes: performing a first biometric determination based on a first image by comparing information extracted from the first image against stored biometric information; performing a second biometric determination based on a second image by comparing information extracted from the second image against stored biometric information; combining outputs of the first and second biometric determinations; and, rendering a match decision or a non-match decision based on the combining of outputs. The first image may be an image of a field of view of an imaging apparatus under illumination from a first illumination source located at a first position relative to the field of view. The second image may be an image of the field of view under illumination from a second illumination source located at a second position relative to the field of view.

### CROSS-REFERENCE TO RELATED APPLICATION

This application is a continuation-in-part application of U.S. patent application Ser. No. 14/738,505, filed on Jun. 12, 2015, now pending, which is herein incorporated by reference in its entirety.

### FIELD OF INVENTION

The invention relates to apparatuses and methods for image based biometric recognition. The invention particularly enables obtaining and processing images of one or more biometric features corresponding to a subject, for the purposes of biometric recognition.

### BACKGROUND

Methods for biometric recognition based on facial features, including features of the eye are known. Methods for eye or iris based recognition implement pattern-recognition techniques to compare an acquired image of a subject's eye or iris against a previously stored image of the subject's eye or iris, and thereby determine or verify identity of the subject. A digital feature set corresponding to an acquired image is encoded based on the image, using mathematical or statistical algorithms. The digital feature set or template is thereafter compared with databases of previously encoded digital templates (stored feature sets corresponding to previously acquired eye or iris images), for locating a match and determining or verifying identity of the subject.

Apparatuses for eye based biometric recognition such as iris recognition typically comprise an imaging apparatus for capturing an image of the subject's eye(s) or iris(es) and an image processing apparatus for comparing the captured image against previously stored eye or iris image information. The imaging apparatus and image processing apparatus may comprise separate devices, or may be combined within a single device.

While eye or iris based recognition apparatuses have been previously available as dedicated or stand alone devices, it is increasingly desirable to incorporate recognition capabilities into handheld devices or mobile communication devices or mobile computing devices (collectively referred to as “mobile devices”) having inbuilt cameras, such as for example, mobile phones, smart phones, personal digital assistants, tablets, laptops, or wearable computing devices.

Implementing eye or iris based recognition in mobile devices is convenient and non-invasive and gives individuals access to compact ubiquitous devices capable of acquiring images of sufficient quality to enable recognition (identification or verification) of identity of an individual. By incorporating eye or iris imaging apparatuses into mobile devices, such mobile devices achieve biometric recognition capabilities, which capabilities may be put to a variety of uses, including access control for the mobile device itself.

Processing of eye or iris based images for the purpose of biometric recognition requires clear, well focused images of a subject's eye. In addition to other image quality criteria, eye or iris recognition requires sufficient usable eye or iris area to enable accurate image recognition. Usable eye or iris area is measured as the percentage of the eye or iris that is not occluded by eyelash(es), eyelid(s), specular reflects, ambient specular reflections or otherwise. Occlusion of the eye or iris not only reduces available textural information for comparison, but also decreases accuracy of the eye or iris segmentation process, both of which increase recognition errors.

In a significant percentage of instances where an eye image is found to have insufficient usable eye or iris area, reduction of or interference with usable eye or iris area is found to have been caused by specular reflections from surfaces of eyewear such as eyeglasses, which specular reflections arise from light generated by illuminators associated with the imaging apparatus. Owing to the fact that intensity of light from a specular reflection is several times greater than intensity of diffuse reflections of light off a surface of a subject's eye, light from a specular reflection obscures the area covered by the specular reflection, and interferes with capture of eye or iris texture information corresponding to the area covered by the specular reflection.

Prior art solutions for addressing this problem have relied on positioning a plurality of illuminators within (or in the vicinity of) an imaging apparatus, and obtaining multiple images of a subject's eye or iris—wherein each image is obtained under illumination from an illuminator selected from the plurality of illuminators. The multiple images are thereafter examined and images in which specular reflections are found to obscure part of the subject's eye or iris are discarded. Images in which specular reflections do not obscure the eye or iris are selected for further image processing and image comparison steps. The prior art approach suffers from multiple drawbacks. A first drawback is that positioning of illuminators to ensure that at least one image of the multiple images is not obscured by specular reflections requires knowledge of an approximate diameter of the area to be imaged, and also the approximate distance of the subject's eye from the illuminators—both of which limit the usefulness and adaptability of the imaging apparatus. Additionally, in cases where specular reflections are caused by eyeglass lenses positioned in front of a subject's eye, the position of a specular reflection formed on an eyeglass lens is affected by the curvature of the eye glass lens—forcing manufacturers of the prior art imaging apparatus to position illuminators based on certain assumptions regarding curvature of eyeglass lenses that are worn by a majority of eyeglass wearing populations. Variations in diameter of a subject's eye, distance of the subject's eye from illuminators, and curvature in an eyeglass lens interposed between illuminators and a subject's eye, reduce the likelihood of a subject's eye not being at least partially obscured by a specular reflection—which in turn results in prior art image processing apparatuses having to acquire and examine a larger number of iris images before a suitable unobscured eye image can be located. It would be understood that the process of acquiring and examining a larger number of iris images results in an increased consumption of processing resources, a corresponding increase in the time necessary to arrive at an identity decision, and a poor user experience.

There is accordingly a need for improved eye based biometric recognition systems that can minimize the impact of specular reflections while obtaining and processing images of a subject's eye.

### SUMMARY

The present invention provides a method for image based biometric recognition. The method comprises the steps of (a) performing a first biometric determination based on a first image, the first biometric determination comprising comparing information extracted from the first image against stored biometric information, (b) performing a second biometric determination based on a second image, the second biometric determination comprising comparing information extracted from the second image against stored biometric information, (c) combining outputs of the first biometric determination and the second biometric determination based on at least one predefined method for combining outputs, and (d) rendering a match decision or a non-match decision based on an output of the combining of outputs. The first image may be an image of a field of view of an imaging apparatus under illumination from a first illumination source located at a first position relative to the field of view. The second image may be an image of the field of view under illumination from a second illumination source located at a second position relative to the field of view.

Acquisition of at least one of the first image and the second image may occur under illumination from only one of the first and second illumination sources. The first and second illumination sources may be alternately pulsed during acquisition of the first and second images. In an embodiment, timing of illumination pulses generated by the first and second illumination sources may be substantially synchronized with an exposure timing of an imaging apparatus at which the first and second images are acquired.

In an exemplary embodiment, at least one predefined method for combining outputs may be selected from a group of predefined methods for combining outputs from more than one biometric determination. Selection of the at least one predefined method may be based on an assessment of quality of at least one of the first and second images in accordance with a predetermined criteria.

According to a specific embodiment of the method, the first and second biometric determinations are eye or iris based biometric determinations, while the predetermined criteria is a specified minimum threshold requirement corresponding to usable eye or iris area within an image under assessment. In another embodiment, the first and second biometric determinations are eye or iris based biometric determinations, while at least one of the first and second images includes two partially or wholly imaged eyes or irises.

The at least one predefined rule for combining outputs may be selected from a group of predefined rules for combining outputs from first and second biometric determinations. Selection may be based on an assessment of quality of at least one of the first and second images in accordance with a predetermined criteria, which predetermined criteria may be a specified minimum threshold requirement corresponding to usable eye or iris area within an image under assessment.

Steps (a) to (d) of the method may be repeated in respect of successively acquired image pairs each comprising first and second images, until occurrence of a termination event. The termination event may comprise any of (i) expiry of a predetermined time interval, (ii) performance of step (a) to (d) in respect of a predetermined number of image pairs, (iii) rendering of a match decision, (iv) distance between an image sensor and a biometric feature of interest exceeding a predetermined maximum distance or (v) a determination that at least one image within an image pair does not include a biometric feature of interest.

The invention additionally provides a system for image based biometric recognition. The system may comprise an imaging apparatus comprising at least one image sensor, a first illumination source located at a first position relative to a field of view corresponding to the imaging apparatus, a second illumination source located at a second position related to the field of view, an illumination controller, and a processing device. The processing device may be configured for (a) performing a first biometric determination based on a first image, the first biometric determination comprising comparing information extracted from the first image against stored biometric information, (b) performing a second biometric determination based on a second image, the second biometric determination comprising comparing information extracted from the second image against stored biometric information, (c) combining outputs of the first biometric determination and the second biometric determination based on at least one predefined rule for combining outputs, and (d) rendering a match decision or a non-match decision based on an output of the combining of outputs. The first image may be an image of the field of view under illumination from the first illumination source, while the second image may be an image of the field of view under illumination from the second illumination source.

The imaging apparatus may acquire at least one of the first image and the second image under illumination from only one of the first and second illumination sources.

The illumination controller may be configured to alternately pulse the first and second illumination sources during acquisition of the first and second images. The illumination controller may additionally or alternately be configured to substantially synchronize illumination pulses generated by the first and second illumination source with an exposure timing of the imaging apparatus.

The processing device may be configured such that at least one predefined rule for combining outputs may be selected from a group of predefined rules for combining outputs from more than one biometric determination. Selection of the at least one predefined rule may be based on an assessment of quality of at least one of the first and second images in accordance with a predetermined criteria.

In a system embodiment, the first and second biometric determinations are eye or iris based biometric determinations, and the predetermined criteria may be a specified minimum threshold requirement corresponding to usable eye or iris area within an image under assessment. In another embodiment, the first and second biometric determinations are eye or iris based biometric determinations, and at least one of the first and second images includes two partially or wholly imaged eyes or irises.

The processing device may be configured such that at least one predefined rule for combining outputs is selected from a group of predefined rules for combining outputs from first and second biometric determinations, which selection is based on an assessment of quality of at least one of the first and second images in accordance with a predetermined criteria. The predetermined criteria may comprise a specified minimum threshold requirement corresponding to usable eye or iris area within an image under assessment.

The processing device may be configured to repeat steps (a) to (d) in respect of successively acquired image pairs each comprising first and second images, until occurrence of a termination event, which termination event may comprise any of (i) expiry of a predetermined time interval, (ii) performance of step (a) to (d) in respect of a predetermined number of image pairs, (iii) rendering of a match decision, (iv) distance between an image sensor and a biometric feature of interest exceeding a predetermined maximum distance or (v) a determination that at least one image within an image pair does not include a biometric feature of interest.

The invention additionally presents a computer program product for iris based biometric recognition, comprising a computer usable medium having a computer readable program code embodied therein, the computer readable program code comprising instructions for performing a method in accordance with one or more of the method embodiments described herein.

### BRIEF DESCRIPTION OF THE ACCOMPANYING DRAWINGS

FIG. 1 is a functional block diagram of an apparatus configured for image based biometric recognition.

FIG. 2 illustrates steps involved in eye or iris image based recognition systems.

FIGS. 3A-3C and 4A-4C illustrate exemplary image frames that include specular reflections.

FIG. 5A illustrates an imaging apparatus and illuminators configured in accordance with an embodiment of the present invention.

FIG. 5B illustrates an exemplary image frame acquired using the imaging apparatus and illuminators of FIG. 5A.

FIGS. 6 and 7 are flowcharts illustrating methods for eye or iris image based recognition according to the present invention.

FIG. 8 illustrates an exemplary computer system in which various embodiments of the invention may be implemented.

### DETAILED DESCRIPTION

The present invention is directed to apparatuses and methods configured for biometric recognition, for example based on eye or iris imaging and processing. In an embodiment, the apparatus of the present invention comprises a mobile device having an eye or iris based recognition system implemented therein.

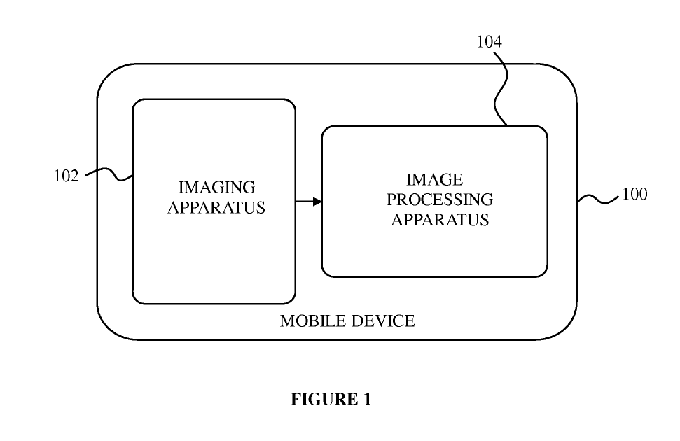

FIG. 1 is a functional block diagram of a mobile device 100 configured for biometric recognition such as eye or iris image based recognition, comprising an imaging apparatus 102 and an image processing apparatus 104. In an embodiment, imaging apparatus 102 acquires an image of the subject's eye or iris and transmits the image to image processing apparatus 104. The image captured by imaging apparatus 102 may be a still image or a video image. Image processing apparatus 104 thereafter analyses the acquired image frame(s) and compares the corresponding digital feature set with digital templates encoded and stored based on previously acquired eye or iris images, to identify the subject, or to verify the subject, or to verify the identity of the subject.

Although not illustrated in FIG. 1, mobile device 100 may include other components, including for extracting still frames from video images, for processing and digitizing image data, for enrolment of eye or iris images (the process of capturing, and storing eye or iris information for a subject, and associating the stored information with that subject) and comparison (the process of comparing eye or iris information acquired from a subject against information previously acquired during enrolment, for identification or verification of the subject's identity), and for enabling communication between components of the mobile device. The imaging apparatus, image processing apparatus and other components of the mobile device may each comprise separate devices, or may be combined within a single mobile device.

Imaging apparatuses for eye or iris based biometric recognition may comprise an image sensor and an optical assembly. The imaging apparatus may comprise a conventional solid state still camera or video camera, and the image sensor may comprise a charged coupled device (CCD) or a complementary metal oxide semiconductor (CMOS) device. The optical assembly may comprise a single unitarily formed element, or may comprise an assembly of optical elements selected and configured for achieving desired image forming properties. The imaging apparatus may have a fixed focus, or a variable focus.

The optical assembly and image sensor may be configured and disposed relative to each other, such that (i) one surface of the image sensor coincides with the image plane of the optical assembly and (ii) the object plane of the optical assembly substantially coincides with an intended position or a subject's eye for iris image acquisition. When the subject's eye is positioned at the object plane, an in-focus image of the eye is formed on the image sensor.

The imaging apparatus may additionally comprise one or more illuminators used to illuminate the eye of the subject being identified. The illuminator may comprise any source of illumination including an incandescent light or a light emitting diode (LED).

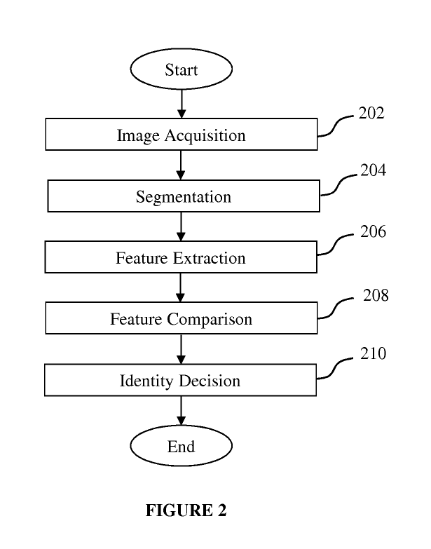

FIG. 2 illustrates steps typically involved in eye or iris image based recognition systems. At step 202, the imaging apparatus acquires an image of the subject's eye or iris.

Segmentation is performed on the acquired image at step 204. Segmentation refers to the step of locating the boundaries of the eye or iris within the acquired image, and cropping the portion of the image which corresponds to the eye or iris. In the case of an iris, since the iris is annular in shape, segmentation typically involves identifying two substantially concentric circular boundaries within the acquired image—which circular boundaries correspond to the inner and outer boundaries of the iris. Several techniques for iris segmentation may be implemented to this end, including for example Daugman's iris segmentation algorithm. Eye or iris segmentation may additionally include cropping of eyelids and eye lashes from the acquired image. It would be understood that segmentation is an optional step prior to feature extraction and comparison that may be avoided entirely. Segmentation is at times understood to comprise a part of feature extraction operations, and is not always described separately.

Subsequently, feature extraction is performed at step 206—comprising processing image data corresponding to the cropped eye or iris image, to extract and encode salient and discriminatory features that represent an underlying biometric trait. For iris images, features may be extracted by applying digital filters to examine texture of the segmented iris images. Application of digital filters may result in a binarized output (also referred to as an “iris code” or “feature set”) comprising a representation of salient and discriminatory features of the iris. Multiple techniques for iris feature extraction may be implemented, including by way of example, application of Gabor filters.

At step 208, a comparison algorithm compares the feature set corresponding to the acquired eye or iris image against previously stored eye or iris image templates from a database, to generate scores that represent a difference (i.e. degree of similarity or dissimilarity) between the input image and the database templates. The comparison algorithm may for example involve calculation of a hamming distance between the feature sets of two images, wherein the calculated normalized hamming distance represents a measure of dissimilarity between two images.

The feature extraction and comparison steps may be integrated into a single step. Equally, the feature extraction step may be omitted entirely, in which case the comparison step may comprise comparing iris image information corresponding to the received frame, with stored eye or iris information corresponding to at least one eye or iris image. For the purposes of this invention, any references to the step of comparison shall be understood to apply equally to (i) comparison between a feature set derived from a feature extraction step and one or more stored image templates, and (ii) comparison performed by comparing image information corresponding to the received frame, with stored information corresponding to at least one eye or iris image.

At step 210, results of the comparison step are used to arrive at a decision (identity decision) regarding identity of the acquired eye or iris image.

For the purposes of this specification, an identity decision may comprise either a positive decision or a negative decision. A positive decision (a “match” or “match decision”) comprises a determination that the acquired eye or iris image (i) matches an eye or iris image or an eye or iris template already registered or enrolled within the system or (ii) satisfies a predetermined degree of similarity with an eye or iris image or an eye or iris template already registered or enrolled within the system. A negative decision (a “non-match” or “non-match decision”) comprises a determination that the acquired eye or iris image (i) does not match any eye or iris image or any eye or iris template already registered or enrolled within the system or (ii) does not satisfy a predetermined degree of similarity with any eye or iris image or any eye or iris template registered or enrolled within the system. In embodiments where a match (or a non-match) relies on satisfaction of (or failure to satisfy) a predetermined degree of similarity with eye or iris images or templates registered or enrolled within the system—the predetermined degree of similarity may be varied depending on the application and requirements for accuracy. In certain devices (e.g. mobile devices) validation of an identity could result in unlocking of, access authorization or consent for the mobile device or its communications, while failure to recognize an eye or iris image could result in refusal to unlock or refusal to allow access. In an embodiment of the invention, the match (or non-match) determination may be communicated to another device or apparatus which may be configured to authorize or deny a transaction, or to authorize or deny access to a device, apparatus, premises or information, in response to the communicated determination.

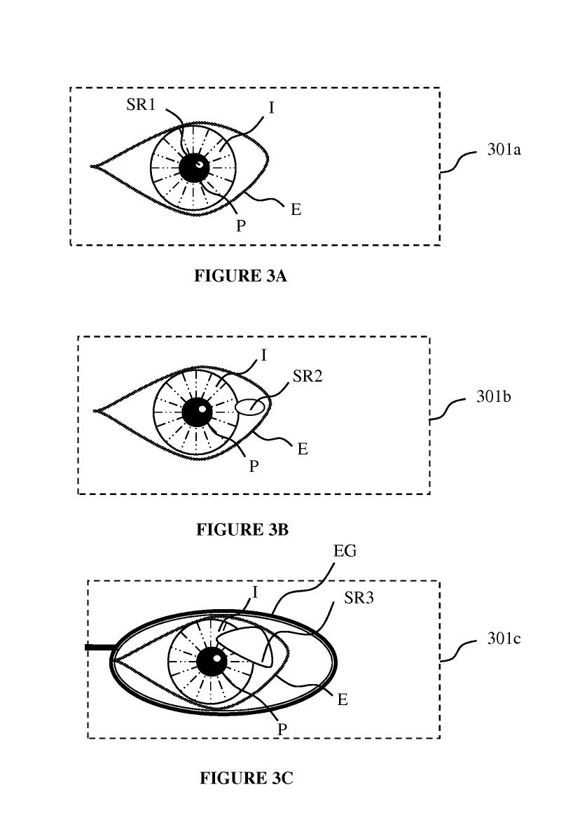

Each of FIGS. 3A, 3B and 3C illustrate an image frame (301a, 301b and 301c) with instances of occlusion or interference with usable eye or iris area as a result of specular reflections.

In FIG. 3A, a subject's eye E comprises iris I and pupil P. Pupil P has specular reflection SR1 obscuring part of the pupil. However, since specular reflection SR1 does not obscure or otherwise interfere with the usable iris area of iris I, such reflections would not affect iris image quality for the purpose of iris recognition. In FIG. 3B on the other hand, specular reflection SR2 is positioned at the perimeter of iris I within eye E. Therefore, specular reflection SR2 significantly reduces usable iris area of iris I.

FIG. 3C illustrates the effect of specular reflections when eyeglass EG comprising at least one lens is interposed between the iris imaging apparatus and a subject's eye. Specular reflection SR3 reflects off a surface of the eyeglass lens and partially obscures part of iris I. Specular reflection SR3 accordingly significantly reduces usable iris area of the iris.

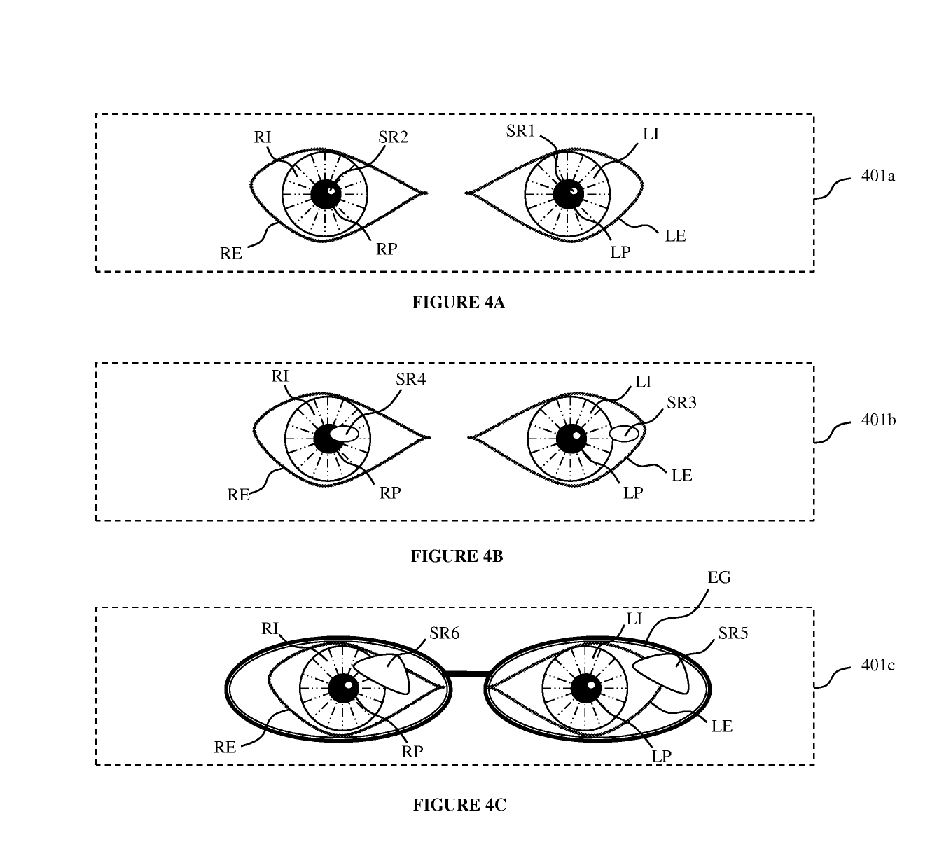

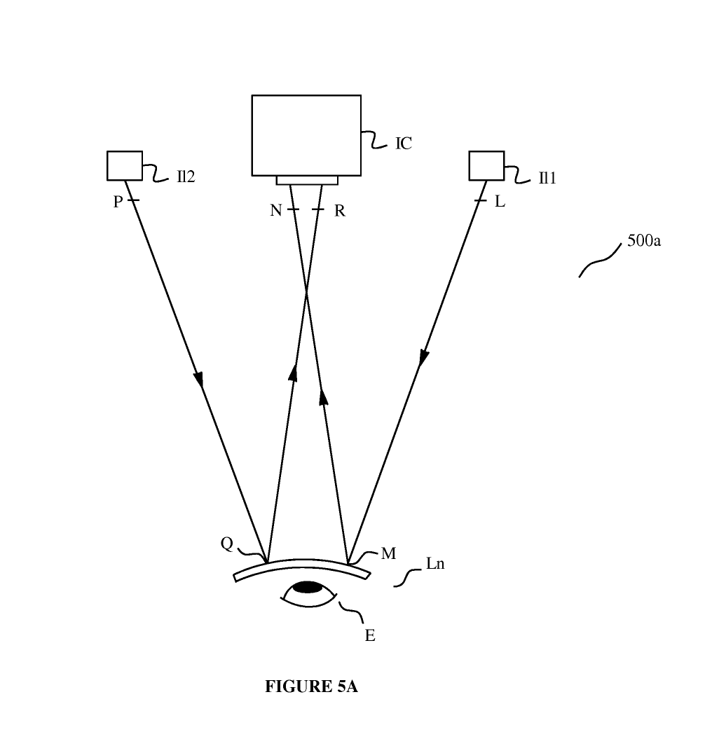

Likewise, each of FIGS. 4A, 4B and 4C illustrate an image frame (401a, 401b and 401c) which images both of a subject's eyes—and which exhibits instances of occlusion or interference with usable eye or iris area as a result of specular reflections.

In FIG. 4A, subject's left eye LE comprises left iris LI and left pupil LP, while right eye RE comprises right iris RI and right pupil RP. It will be noted that left pupil LP and right pupil RP respectively have specular reflections SR1 and SR2 obscuring part of the pupil. However, since specular reflections SR1 and SR2 do not obscure or otherwise interfere with the usable iris area of either left iris LI or right iris RI, such reflections would not affect iris image quality for the purpose of iris recognition.

In FIG. 4B on the other hand, specular reflection SR3 is positioned at the perimeter of left iris LI within left eye LE, while specular reflection SR4 partially obscures part of right iris RI and part of right pupil RP. Therefore, specular reflection SR4 significantly reduces usable iris area of right iris RI, whereas specular reflection SR3 has little or no impact on the usable iris area of left iris LI.

FIG. 4C illustrates the effect of specular reflections when a pair of eyeglasses EG comprising two lenses is interposed between the iris imaging apparatus and a subject's eyes. Specular reflection SR5 reflects off a surface of the left lens (which is interposed between the iris imaging apparatus and a subject's left eye LE) such that it does not interfere or obscure any part of left iris LI within left eye LE. Specular reflection SR6 on the other hand reflects off a surface of the right lens (which is interposed between the iris imaging apparatus and the subject's right eye RE) and partially obscures part of right iris RI. Specular reflection SR6 accordingly significantly reduces usable iris area of right iris RI, whereas specular reflection SR5 has no impact on the usable iris area of left iris LI.

FIGS. 3A to 4C establish that the position of specular reflections with respect to the position of a subject's eye or iris within an image can have significant consequences for the usable eye or iris area available within the image. The position and emission patterns of illumination sources associated with an imaging apparatus has consequences for the incidence of specular reflections as well as the position of such specular reflections relative to a subject's eye or iris. The present invention seeks to overcome interference caused by specular reflections arising from illumination sources associated with an imaging apparatus.

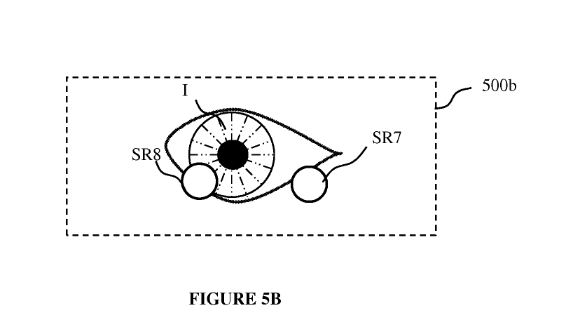

FIG. 5A illustrates an embodiment 500a of the invention, wherein a subject's eye E is positioned within the field of view of an iris imaging apparatus IC. In the illustration, eyeglass lens Ln is positioned between the subject's eye E and the imaging apparatus. Imaging apparatus IC is provided with two illumination sources Il1 and Il2 (disposed as opposite sides of imaging apparatus IC), which are positioned to illuminate objects within the field of view of imaging apparatus IC.

In FIG. 5A, light path L-M-N originates at illumination source Il1 and produces a specular reflection at point M on lens Ln. Likewise, light path P-Q-R originates at illumination source Il2 and produces a specular reflection at point Q on lens Ln. As can be observed, the specular reflection at point Q (arising from illumination generated at illumination source Il2) lies between the imaging apparatus IC and the subject's eye E and therefore obscures a part of the subject's eye, whereas the specular reflection at point M (arising from illumination generated at illumination source Il1) does not lie between the imaging apparatus IC and the subject's eye and therefore does not reduce or interfere with usable iris area.

FIG. 5B illustrates an image 500b as acquired by the imaging apparatus IC of FIG. 5A. The image 500b includes iris I, as well as specular reflection SR7 (corresponding to light path L-M-N originating at illuminator Il1) and specular reflection SR8 (corresponding to light path P-Q-R originating at illuminator Il2). As shown in FIG. 5B specular reflection SR8 interferes with usable iris area of iris I, whereas specular reflection SR7 does not.

It has accordingly been discovered that multiple illumination sources associated with an iris imaging apparatus (such as illumination sources Il1 and Il2 at the same time), can be pulsed or flashed alternately (and preferably synchronized with exposure times of the imaging apparatus) for the purpose of iris image capture. By turning off a first illumination source (such as Il2) that is responsible for generating a specular reflection (such as SR8) that interferes with or reduces usable iris area, and simultaneously illuminating the subject's eye with a second illumination source (such as Il1) which generates a specular reflection (such as SR7) that does not interfere with or reduce usable iris area, the accuracy of image recognition processes can be improved.

While not illustrated in FIG. 5A, it would be understood that the process of turning illumination sources on and off (and for achieving synchronization with exposure timings) can be done using one or more strobing devices and/or illumination controllers.

While the embodiment illustrated in FIG. 5A shows two illumination sources in a horizontal arrangement on opposing sides of the imaging apparatus, it would be understood that (i) the imaging apparatus may include more than two illumination sources, and (ii) the multiple light sources may be arranged in any configuration, including horizontally, vertically or radially, such that one or more illumination sources responsible for eye or iris obscuring specular reflections can be turned off, while still leaving sufficient non-obscuring illumination sources on to properly illuminate an eye or iris for biometric recognition purposes.

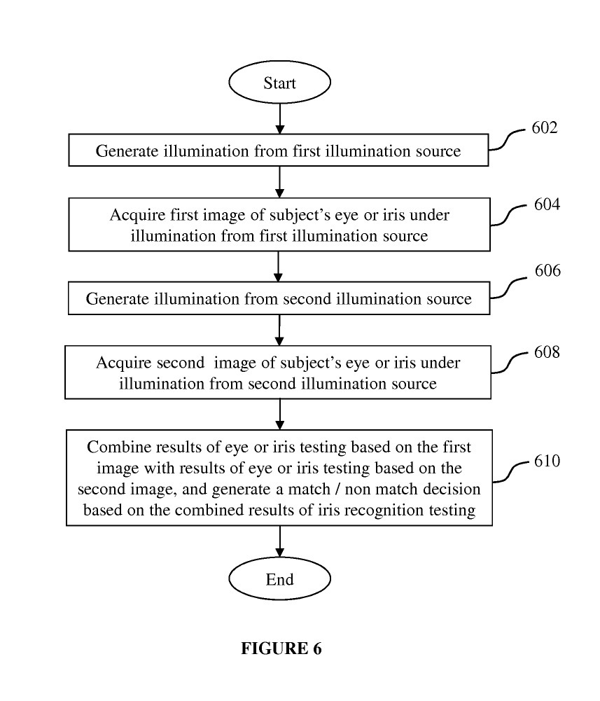

The invention additionally relies on the discovery that results of two or more biometric tests may be combined for an enhanced test. FIG. 6 illustrates a method embodiment of the present invention—which seeks to combine results of two or more biometric tests to reduce or address the consequences of specular reflection related interference with usable eye or iris area. The method relies on an imaging apparatus having at least a first illumination source and a second illumination source, and an illumination controller and/or a strobing device configured inter alia to control activation (turning on) and deactivation (turning off) of both illumination sources, along with the timing of such activation and deactivation. The illumination controller and/or strobing device can be configured to turn the first and second illumination sources on and off in various strobing and timing patterns.

At step 602, the illumination controller activates a first illumination source to generate illumination therefrom. Step 604 comprises acquiring a first image of a subject's eye or iris under illumination from the first illumination source (i.e. while the first illumination source is on). In an embodiment of the invention, a second illumination source is deactivated or turned off for the duration of acquisition of the first image at step 604.

At step 606, the illumination controller activates the second illumination source to generate illumination therefrom. Step 608 comprises acquiring a second image of a subject's eye or iris under illumination from the second illumination source (i.e. while the second illumination source is on). In an embodiment, the first illumination source is deactivated for the duration of acquisition of the second image at step 608.

Step 610 comprises combining (i) results of eye or iris based biometric testing based on the first image with (ii) results of eye or iris based biometric testing based on the second image, and generating a match or non-match decision based on the combined results of eye or iris recognition testing.

The combining of results at step 610 may be based on one or more rules for combining results of biometric testing. In an embodiment, a rule for combining results may be selected from among a plurality of different rules, each of which specify a unique method of combining results of eye or iris recognition testing based on a first eye or iris image with results of eye or iris recognition testing based on a second eye or iris image.

Each rule for combining results of testing using first and second eye or iris images, may describe a method of combining results of two independent biometric tests. Exemplary rules for combining results may include:
a disjunctive acceptance test—i.e. wherein a match decision is arrived at responsive to a match determination in respect of either of the eye or iris images.
a conjunctive acceptance test—i.e. wherein a match decision is arrived at responsive to a match determination in respect of both of the eye or iris images.
one or more rules for arriving at a match decision based on fusion (combination) of information from multiple sources of biometric information. Exemplary (and non-limiting) embodiments of rules for arriving at a match decision based on fusion of biometric information include:
   combining multiple biometric traits—where a match or non-match decision is based on eye or iris based biometric information combined with biometric information corresponding to one or more other biometric traits (such as for example, fingerprints information, retina information, face recognition, palm prints etc.)
   combining information corresponding to both of a subject's eyes or irises—where a match or non-match decision is based on eye or iris based biometric information corresponding to a subject's left eye combined with eye or iris based biometric information corresponding to the subject's right eye
   combining multiple image samples of the same eye or iris—where a match or non-match decision is based on eye or iris based biometric information corresponding to one or both of a subject's eyes or irises, which images are acquired (i) in a time phased manner, or (ii) under differing imaging conditions, or (iii) under differing illumination conditions or (iv) at different image sensors.
   combining multiple image representations and/or matching algorithms—where a match or non-match decision is based on a combination of at least a first approach or algorithm for achieving feature extraction, eye or iris texture extraction and/or matching algorithms with at least a second approach or algorithm for achieving feature extraction, eye or iris texture extraction and/or matching algorithms, which first and second approach or algorithm are different from each other.

A decision regarding selection of a specific rule from among the plurality of rules for combining results may be arrived at in response to a determination that assessed image quality of one or both of the first and second imaged eyes meets a predetermined criteria. Exemplary predetermined criteria include:
Either one of the imaged eyes failing to satisfy one or more minimum thresholds for eye or iris image quality.
Both of the imaged eyes failing to satisfy one or more minimum thresholds for eye or iris image quality.
Assessed image quality parameters for one or both of the imaged eyes satisfying one or more prescribed parameter values, or falling within a prescribed range of parameter values.

In an embodiment of the invention, each predefined criteria may be mapped to one or more specific rules for combining results of eye or iris recognition testing respectively based on the first and second eye or iris images—such that said one ore more specific rules for combining results would be invoked responsive to a determination that the corresponding predefined criteria has been met.

In implementation, it would be understood that the first image frame of a subject's eye and the second image frame of the subject's eye may comprise successive image frames acquired or received from the imaging apparatus (for example, successive image frames within a video clip of the subject's eye(s). In another embodiment, the first image frame and second image frame of the subject's eye are selected from a set of image frames sequentially generated by the imaging apparatus, such that the first image frame is separated from the second image frame by at least one intermediate image frame—which intermediate image frame is generated by the imaging apparatus as a sequentially intermediate frame between the first image frame and the second image frame. Selection of the first and second image frames from among the set of sequentially generated image frames may be based on one or more predetermined criteria, including (i) a prescribed number of intermediate frames separating the first image frame and the second image frame (ii) a predefined time interval separating time of generation (at an image sensor) or time of receiving (at a processor or memory) of the first image frame and the second image frame respectively (in a preferred embodiment, this time interval may be any interval between 5 milliseconds and 2 seconds) or (iii) availability status of a resource required for performing image processing or image comparison or combining of results of image comparisons.

While not illustrated in FIG. 6, if a match is found based on the combining of results at step 610, the method may terminate. If on the other hand, a match is not found based on the combining of results at step 610, the method may loop back and re-perform steps 602 to 610 (comprising acquiring a fresh set of images comprising a first eye or iris image and a second eye or iris image under illumination from the first illumination source and the second illumination source respectively, and generating a match or non-match decision based on the combined results of eye or iris recognition testing using the fresh set of images). It will however be understood that this looping step is optional, and a variant of the method of FIG. 6 may be performed by searching for a match based on a fixed number of image frame pairs, or by terminating the method after combining and generating a match/non-match decision on image frames pairs (i) for a fixed period of time (i.e. until the method times out) or (ii) for a predetermined or fixed number of image frame pairs or (iii) until any time after a match decision has been rendered or (iv) until cancelled, timed out or otherwise stopped without a match decision having been rendered. In one embodiment of the invention, each successive iteration or loop of steps 602 to 610 is performed in response to a non-match decision, without communicating or otherwise notifying the non-match decision (and/or execution of a successive iteration or loop of steps 602 to 601) to the user. The user would receive communication or notification of a non-match decision only after termination of the method in accordance with one or more of the termination events described herein. In an embodiment, the method may be terminated in response to a determination that one or more images acquired by an image sensor do not include a subject's eye or iris or other biometric feature of interest. In another embodiment, the method may be terminated in response to a sensor based determination that the distance between the imaging sensor (or the imaging apparatus or the device housing such apparatus or sensor) and the subject has exceeded a predetermined maximum distance or. Sensors capable of such determination include proximity sensors, such as capacitive sensors, capacitive displacement sensors, doppler effect sensors, eddy current sensors, inductive sensors, laser rangefinder sensors, magnetic sensors (including magnetic proximity sensors) passive optical sensors (including charge coupled devices), thermal infrared sensors, reflective photocell sensors, radar sensors, reflection based sensors, sonar based sensors or ultrasonic based sensors, In another embodiment, the method may be terminated if (i) an eye or iris that was present in one or both image frames within a preceding image frame pair is found to be absent in image frames within a subsequent image frame pair or (ii) if a size of the eye or iris in subsequent image frame pairs is found to decrease—indicating that the imaging device is being removed from the vicinity of the subject's eye.

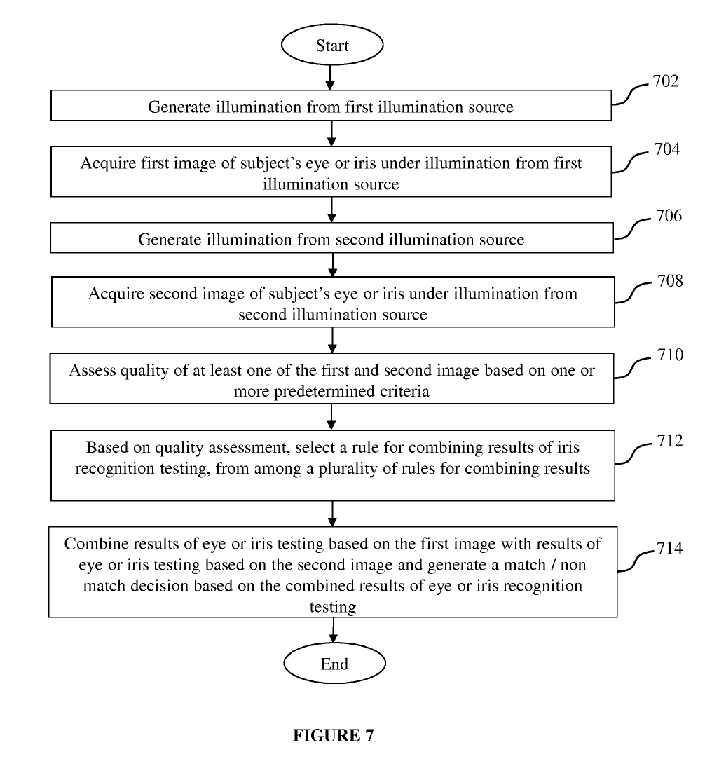

FIG. 7 illustrates a more specific embodiment of the method described generally in connection with FIG. 6.

At step 702, the illumination controller activates a first illumination source to generate illumination therefrom. Step 704 comprises acquiring a first image of a subject's eye or iris under illumination from the first illumination source (i.e. while the first illumination source is on). In an embodiment of the invention, a second illumination source is deactivated or turned off for the duration of acquisition of the first image at step 704.

At step 706, the illumination controller activates the second illumination source to generate illumination therefrom. Step 708 comprises acquiring a second image of a subject's eye or iris under illumination from the second illumination source (i.e. while the second illumination source is on). In an embodiment, the first illumination source is deactivated for the duration of acquisition of the second image at step 708.

Step 710 comprises assessing quality of each of the first image and the second image for image quality assessment.

Responsive to the assessed image quality of at least one of the first image and the second image matching at least one predefined criteria, step 712 selects a corresponding rule for combining results of eye or iris recognition testing based on the first image with results of eye or iris recognition testing based on the second image. The rule for combining results may be selected from among a plurality of different rules, each of which specify a unique method of combining results of eye or iris recognition testing based on the first image with results of eye or iris recognition testing based on the second image. Step 714 combines results of eye or iris recognition testing respectively based on the first and second images and generates a match/non-match decision based on the combined results of the eye or iris recognition testing. For the purposes of the embodiment of FIG. 7, rules for combining results and predetermined criteria for selection of such rules may be applied in the same manner described previously in connection with FIG. 6.

While the illustrations of FIGS. 5A and 5B show an imaging apparatus (having a first and second illumination sources) being used to acquire images of a single eye, the apparatus of FIG. 5A and the methods of FIGS. 6 and 7 can also be modified for or applied to eye or iris based biometric recognition systems that rely on a dual eye configuration i.e. which acquire and process information relating to both of a subject's eyes or irises within a single image. In the dual eye embodiments, a first image which includes images of a subject's left and right eye may be acquired under illumination from a first illumination source, while a second image which includes images of the subject's left and right eye may be acquired under illumination from a second illumination source. Eye or iris texture information corresponding to one or both eyes or irises within the first image may be used as input for a first eye or iris based biometric test. Likewise, eye or iris texture information corresponding to one or both eyes or irises within the second image may be used as input for a second eye or iris based biometric test. The results of the first and second eye or iris based biometric tests may thereafter be combined, and a match or non-match decision may be generated based on the combined results of the first and second tests.

While the embodiments of the present invention have been described in terms of eye or iris based biometric recognition, the invention can alternately be implemented or adapted for any image based biometric recognition techniques, or for that matter any techniques that rely on image analysis or image recognition.

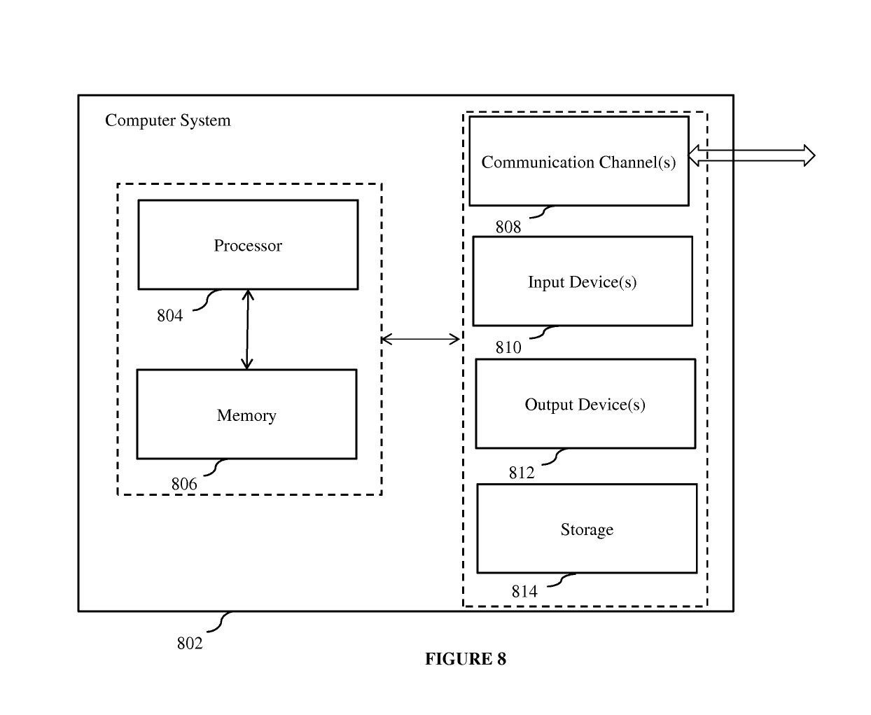

FIG. 8 illustrates an exemplary system in which various embodiments of the invention may be implemented.

The system 802 comprises at least one processor 804 and at least one memory 806. The processor 804 executes program instructions and may be a real processor. The processor 804 may also be a virtual processor. The computer system 802 is not intended to suggest any limitation as to scope of use or functionality of described embodiments. For example, the computer system 802 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 806 may store software for implementing various embodiments of the present invention. The computer system 802 may have additional components. For example, the computer system 802 includes one or more communication channels 808, one or more input devices 810, one or more output devices 812, and storage 814. An interconnection mechanism (not shown) such as a bus, controller, or network, interconnects the components of the computer system 802. In various embodiments of the present invention, operating system software (not shown) provides an operating environment for various softwares executing in the computer system 802, and manages different functionalities of the components of the computer system 802.

The communication channel(s) 808 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 810 may include, but not limited to, a touch screen, a keyboard, mouse, pen, joystick, trackball, a voice device, a scanning device, or any another device that is capable of providing input to the computer system 802. In an embodiment of the present invention, the input device(s) 810 may be a sound card or similar device that accepts audio input in analog or digital form. The output device(s) 812 may include, but not limited to, a user interface on CRT or LCD, printer, speaker, CD/DVD writer, LED, actuator, or any other device that provides output from the computer system 802.

The storage 814 may include, but not limited to, magnetic disks, magnetic tapes, flash memory, CD-ROMs, CD-RWs, DVDs, any types of computer memory, magnetic stripes, smart cards, printed barcodes or any other transitory or non-transitory medium which can be used to store information and can be accessed by the computer system 802. In various embodiments of the present invention, the storage 814 contains program instructions for implementing the described embodiments.

While not illustrated in FIG. 8, the system of FIG. 8 may further include some or all of the components of an image apparatus of the type more fully described in connection with FIG. 1 hereinabove.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 802. The method described herein is typically implemented as a computer program product, comprising a set of program instructions which is executed by the computer system 802 or any other similar device. The set of program instructions may be a series of computer readable codes stored on a tangible medium, such as a computer readable storage medium (storage 814), for example, diskette, CD-ROM, ROM, flash drives or hard disk, or transmittable to the computer system 802, via a modem or other interface device, over either a tangible medium, including but not limited to optical or analogue communications channel(s) 808, or implemented in hardware such as in an integrated circuit. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for image based biometric recognition, comprising the steps of:
(a) performing a first biometric determination based on a first image, the first biometric determination comprising comparing information extracted from the first image against stored biometric information;
(b) performing a second biometric determination based on a second image, the second biometric determination comprising comparing information extracted from the second image against stored biometric information;
(c) combining outputs of the first biometric determination and the second biometric determination based on at least one predefined method for combining outputs; and
(d) rendering a match decision or a non-match decision based on an output of the combining of outputs;
wherein the first image is an image of a field of view of an imaging apparatus under illumination from a first illumination source located at a first position relative to the field of view,
and wherein the second image is an image of the field of view under illumination from a second illumination source located at a second position relative to the field of view.

2. The method as claimed in claim 1, wherein acquisition of at least one of the first image and the second image occurs under illumination from only one of the first and second illumination sources.

3. The method as claimed in claim 1, wherein the first and second illumination sources are alternately pulsed during acquisition of the first and second images.

4. The method as claimed in claim 1, wherein timing of illumination pulses generated by the first and second illumination sources is substantially synchronized with an exposure timing of an imaging apparatus at which the first and second images are acquired.

5. The method as claimed in claim 1, wherein the at least one predefined method for combining outputs is selected from a group of predefined methods for combining outputs from more than one biometric determination.

6. The method as claimed in claim 5, wherein selection of the at least one predefined method is based on an assessment of quality of at least one of the first and second images in accordance with a predetermined criteria.

7. The method as claimed in claim 6, wherein:
the first and second biometric determinations are eye or iris based biometric determinations; and
the predetermined criteria is a specified minimum threshold requirement corresponding to usable eye or iris area within an image under assessment.

8. The method as claimed in claim 1, wherein:
the first and second biometric determinations are eye or iris based biometric determinations; and
at least one of the first and second images includes two partially or wholly imaged eyes or irises.

9. The method as claimed in claim 8, wherein:
the at least one predefined rule for combining outputs is selected from a group of predefined rules for combining outputs from first and second biometric determinations, which selection is based on an assessment of quality of at least one of the first and second images in accordance with a predetermined criteria;
and wherein the predetermined criteria is a specified minimum threshold requirement corresponding to usable eye or iris area within an image under assessment.

10. The method as claimed in claim 1, wherein steps (a) to (d) are repeated in respect of successively acquired image pairs each comprising first and second images, until occurrence of a termination event, which termination event may comprise any of (i) expiry of a predetermined time interval, (ii) performance of step (a) to (d) in respect of a predetermined number of image pairs, (iii) rendering of a match decision, (iv) distance between an image sensor and a biometric feature of interest exceeding a predetermined maximum distance or (v) a determination that at least one image within an image pair does not include a biometric feature of interest.

11. A system for image based biometric recognition, comprising:
an imaging apparatus comprising at least one image sensor;
a first illumination source located at a first position relative to a field of view corresponding to the imaging apparatus;
a second illumination source located at a second position related to the field of view;
an illumination controller; and
a processing device configured for:
(a) performing a first biometric determination based on a first image, the first biometric determination comprising comparing information extracted from the first image against stored biometric information;
(b) performing a second biometric determination based on a second image, the second biometric determination comprising comparing information extracted from the second image against stored biometric information;
(c) combining outputs of the first biometric determination and the second biometric determination based on at least one predefined rule for combining outputs; and
(d) rendering a match decision or a non-match decision based on an output of the combining of outputs;
wherein the first image is an image of the field of view under illumination from the first illumination source;
and wherein the second image is an image of the field of view under illumination from the second illumination source.

12. The system as claimed in claim 11, wherein the imaging apparatus acquired at least one of the first image and the second image under illumination from only one of the first and second illumination sources.

13. The system as claimed in claim 11, wherein the illumination controller is configured to alternately pulse the first and second illumination sources during acquisition of the first and second images.

14. The system as claimed in claim 11, wherein the illumination controller is configured to substantially synchronize illumination pulses generated by the first and second illumination source with an exposure timing of the imaging apparatus.

15. The system as claimed in claim 11, wherein the at least one predefined rule for combining outputs is selected from a group of predefined rules for combining outputs from more than one biometric determination.

16. The system as claimed in claim 15, wherein selection of the at least one predefined rule is based on an assessment of quality of at least one of the first and second images in accordance with a predetermined criteria.

17. The system as claimed in claim 16, wherein:
the first and second biometric determinations are eye or iris based biometric determinations; and
the predetermined criteria is a specified minimum threshold requirement corresponding to usable eye or iris area within an image under assessment.

18. The system as claimed in claim 11, wherein:
the first and second biometric determinations are eye or iris based biometric determinations; and
at least one of the first and second images includes two partially or wholly imaged eyes or irises.

19. The system as claimed in claim 18, wherein:
the at least one predefined rule for combining outputs is selected from a group of predefined rules for combining outputs from first and second biometric determinations, which selection is based on an assessment of quality of at least one of the first and second images in accordance with a predetermined criteria;
and wherein the predetermined criteria is a specified minimum threshold requirement corresponding to usable eye or iris area within an image under assessment.

20. The system as claimed in claim 11, wherein the processing device is configured to repeat steps (a) to (d) in respect of successively acquired image pairs each comprising first and second images, until occurrence of a termination event, which termination event may comprise any of (i) expiry of a predetermined time interval, (ii) performance of step (a) to (d) in respect of a predetermined number of image pairs, (iii) rendering of a match decision, (iv) distance between an image sensor and a biometric feature of interest exceeding a predetermined maximum distance or (v) a determination that at least one image within an image pair does not include a biometric feature of interest.

21. A computer program product for iris based biometric recognition, comprising a computer usable medium having a computer readable program code embodied therein, the computer readable program code comprising instructions for:
(a) performing a first biometric determination based on a first image, the first biometric determination comprising comparing information extracted from the first image against stored biometric information;
(b) performing a second biometric determination based on a second image, the second biometric determination comprising comparing information extracted from the second image against stored biometric information;
(c) combining outputs of the first biometric determination and the second biometric determination based on at least one predefined rule for combining outputs; and
(d) rendering a match decision or a non-match decision based on an output of the combining of outputs;
wherein the first image is an image of a field of view of an imaging apparatus under illumination from a first illumination source located at a first position relative to the field of view,
and wherein the second image is an image of the field of view under illumination from a second illumination source located at a second position relative to the field of view.
